(19) United States
(12) Patent Application Publication
(10) Pub. No.: US 2017/0049256 A1
(43) Pub. Date: Feb. 23, 2017

(54) DEVICES FOR PRESSING FOOD INTO LIQUID

(71) Applicant: Azizbek Razakov, Brooklyn, NY (US)

(72) Inventor: Azizbek Razakov, Brooklyn, NY (US)

(21) Appl. No.: 15/243,117

(22) Filed: Aug. 22, 2016

Related U.S. Application Data
(60) Provisional application No. 62/207,924, filed on Aug. 21, 2015.

(51) Int. Cl. A47J 19/02; A47J 19/06

(52) U.S. Cl. CPC A47J 19/025; A47J 19/06

(57) ABSTRACT

Devices for pressing food into liquid are provided. In some embodiments, devices for pressing food into liquid comprise: a drinking bottle having an interior portion; and a food press mounted in the interior portion of the drinking bottle, wherein the food press comprises: a handle; a shaft connected to the handle so that when the handle is rotated the shaft rotates; a plunger configured to move along the shaft in response to the shaft rotating; a press body having an open end configured to receive the plunger, an interior portion configured to allow the plunger to move from the open end toward an opposite end of the press body; and a plurality of holes at or near the opposite end.

### CROSS REFERENCE TO RELATED APPLICATION

This application claims the benefit of U.S. Provisional Patent Application No. 62/207,924, filed Aug. 21, 2015, which is hereby incorporated by reference herein in its entirety.

### BACKGROUND

In an effort to avoid artificial ingredients and excessive sugar, many people are seeking beverages that are naturally flavored. For example, a person may desire a strawberry flavored water drink, but not want to buy commercially available drinks because the strawberry flavoring in the water is artificial. Instead, the person may want to put juice from fresh strawberries in a container of water.

One way this may be accomplished is to finely cut up strawberries and place them in a container of water. This approach however requires significant effort in cutting up the strawberries (which is difficult to do on the go) and significant time in waiting for the chopped-up strawberries to diffuse into the water.

Another way to accomplish this may be to put a hand juice extractor and pour the resulting juice into a container of water. This approach similarly requires significant effort in squeezing the strawberries into a liquid form in a bowl and then pouring the bowl contents into the water (which is also difficult to do on the go).

Accordingly, new devices for pressing food into liquid are desirable.

### SUMMARY

Devices for pressing food into liquid are provided. In some embodiments, devices for pressing food into liquid comprise: a drinking bottle having an interior portion; and a food press mounted in the interior portion of the drinking bottle, wherein the food press comprises: a handle; a shaft connected to the handle so that when the handle is rotated the shaft rotates; a plunger configured to move along the shaft in response to the shaft rotating; a press body having an open end configured to receive the plunger, an interior portion configured to allow the plunger to move from the open end toward an opposite end of the press body; and a plurality of holes at or near the opposite end.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 is a side view of an example of a drinking bottle including a food press in accordance with some embodiments.

FIG. 2 is a cross-sectional side view of an example of a food press when disassembled in accordance with some embodiments.

FIG. 3 is another cross-sectional side view of the food press of FIG. 2 in accordance with some embodiments.

FIG. 4 is a cross sectional side view of the food press of FIG. 2 when assembled in accordance with some embodiments.

FIG. 5 is a perspective view of the food press of FIG. 2 in accordance with some embodiments.

FIG. 6 is a top view of an example of a drinking bottle in accordance with some embodiments.

FIG. 7 is a top view of an example of a handle of a food press in accordance with some embodiments.

FIG. 8 is a top view of an example of a plunger of the food press of FIG. 2 in accordance with some embodiments.

FIG. 9 is a cross-sectional side view of another example of a food press when disassembled in accordance with some embodiments.

FIG. 10 is a cross sectional side view of the food press of FIG. 9 when assembled in accordance with some embodiments.

FIG. 11 is a top view of an example of a plunger of the food press of FIG. 9 in accordance with some embodiments.

FIG. 12 is a cross-sectional side view of yet another example of a drinking bottle including a food press when disassembled in accordance with some embodiments

FIG. 13 is a cross-sectional side view of still another example of a drinking bottle including a food press when disassembled in accordance with some embodiments

FIG. 14 is a cross-sectional view of an additional example of a pitcher including a food press when assembled in accordance with some embodiments.

### DETAILED DESCRIPTION

Devices for pressing food into liquid are provided. More particularly, in some embodiments, a drinking bottle with a food press mounted therein is provided. In order to press components of food into a liquid, the devices provide a press body in which one or more food items (which can be any suitable food items, such as fruit, vegetables, herbs, spices, etc.) can be placed. The press body includes an open top and generally closed side(s) and bottom. A plunger can then be placed in a top portion of the press body and screwed toward the bottom using a handle and a shaft that engages the plunger. In some embodiments in which the plunger rotates as it moves downward in the press body, a bottom surface of the plunger may be configured to grind the food items as the plunger moves downward. As the food items are compressed and/or ground, components of the food items (which can be liquid and/or solid), can be forced through holes at or near the bottom (e.g., on the bottom or side(s)) (or at any suitable locations on the press body) of the press body. Once the components are pressed out of the press body through these holes, the components can mix with the contents (e.g., existing liquid and/or solids) of the drinking bottle.

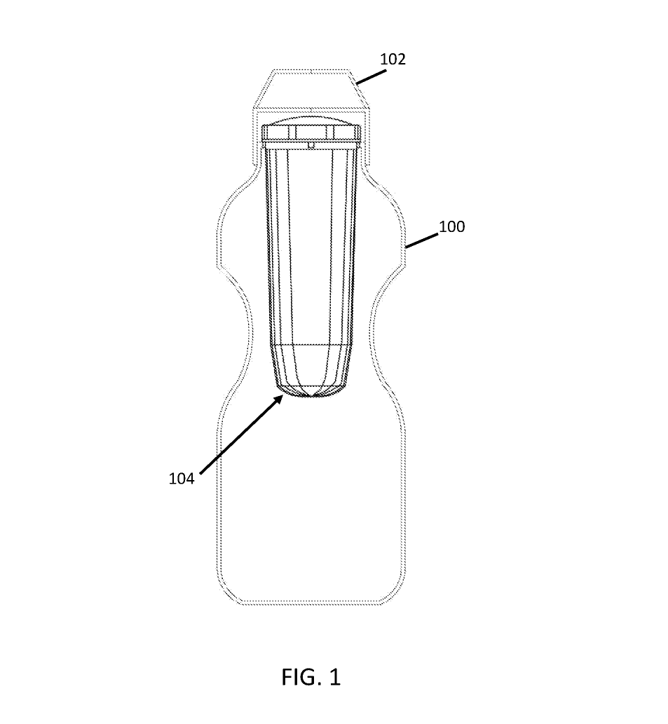

Referring to FIG. 1, a drinking bottle 100 with lid 102 incorporating a food press 104 in accordance with some embodiments is illustrated. As shown, press 104 fits inside bottle 100. In some embodiments, press 104 is secured in bottle 100 so that a body of the press does not move with respect to the bottle.

In some embodiments, lid 102 is removable from drinking bottle 100. In some embodiments, lid 102 can include a hole, a mouthpiece, and/or a closable cap that can allow a user to consume contents from the bottle without removing the lid. When closed, the lid and the cap (if provided) can seal the drinking bottle so that contaminants cannot enter the bottle and the contents of the bottle cannot escape (i.e., leak).

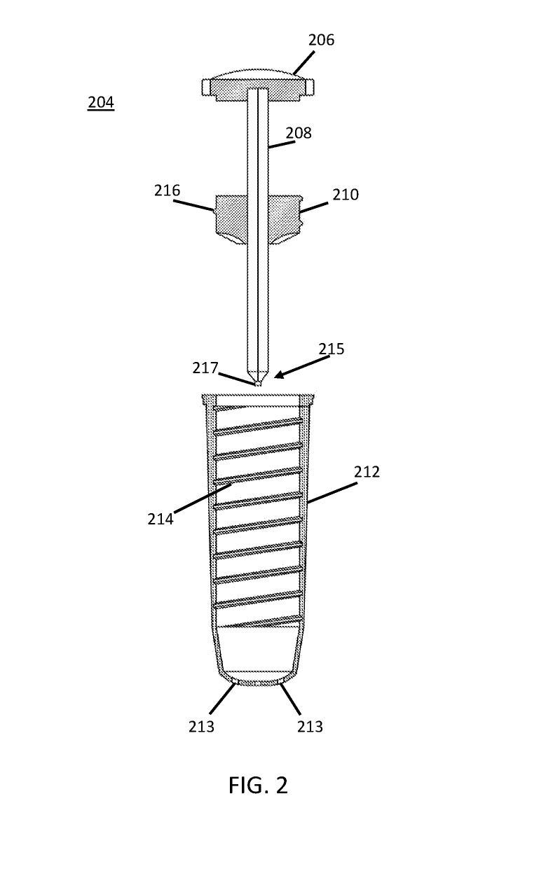

Turning to FIG. 2, an example 204 of a food press that can be used as food press 104 in accordance with some embodiments is shown. As illustrated, press 204 is formed from a handle 206, a shaft 208, a plunger 210, and a press body 212. On the inside of press body 212, threads 214 can be provided. Mating threads 216 can also be provided on plunger 210. When the press is assembled, plunger 210 is movably positioned on shaft 208 so that the plunger can move along the length of the shaft, but the plunger does not rotate with respect to the shaft. As a user of the press rotates the handle, the shaft and the plunger rotate together, which causes the plunger to move along the length of the shaft under the interaction of the threads on the plunger and the threads on the press body. In other words, the plunger screws into the press body.

In order to prevent the plunger from rotating with respect to the shaft, the shaft and a mating hole in the plunger may have any suitable mating cross-sectional shapes. For example, the shapes may be triangular, square, pentagonal, etc. More particularly, as shown in FIG. 8, which illustrates a top down view of an example 810 of a plunger that can be used as plunger 210 in some embodiments, the plunger can have a square hole in it to engage a square shaft.

In some embodiments, end 215 of shaft 208 that is distal from handle 206 can be pointed to enable the shaft to penetrate food items placed in the press body. In some embodiments, end 215 of shaft 208 can include a cylindrical portion 217 that engages a hole in the press body when the shaft is fully inserted in order to provide lateral support to the shaft.

Holes 213 can be provided in press body 212 to allow liquid and/or small solid components of food items to be pressed out of press 204 as plunger 210 moves toward the bottom of the press body. While these holes are illustrated as being at or near the bottom of the press body, these holes can be provided at any suitable location on the press body (including near the top, at or near the bottom, or anywhere in between).

The outside of press body 212 can have any suitable shape. For example, as shown, the shape can be generally cylindrical with a rounded bottom (e.g., shaped like an inverted silo).

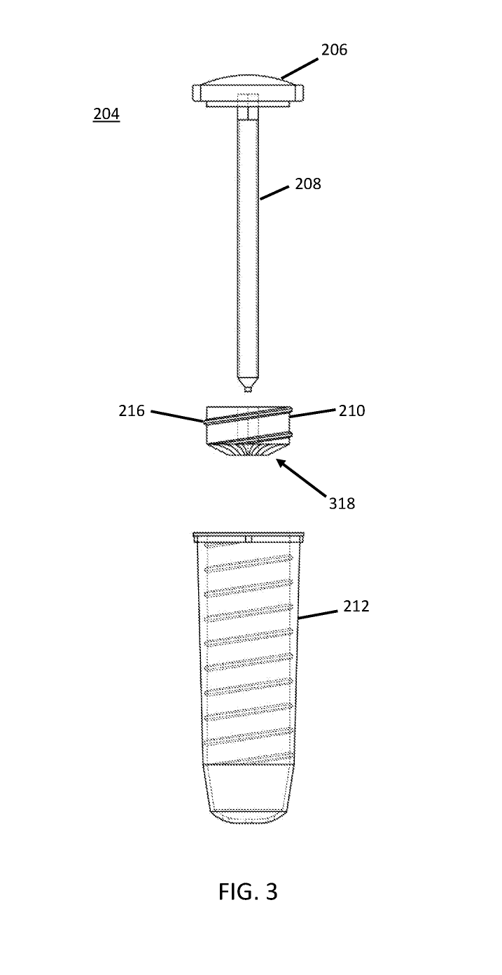

FIG. 3 illustrates further detail of plunger 210 in accordance with some embodiments. As shown, the bottom side of plunger 210 can include a grinding surface 318 composed of a series of radial ridges that grind food in the press as the plunger rotates and moves along shaft 208.

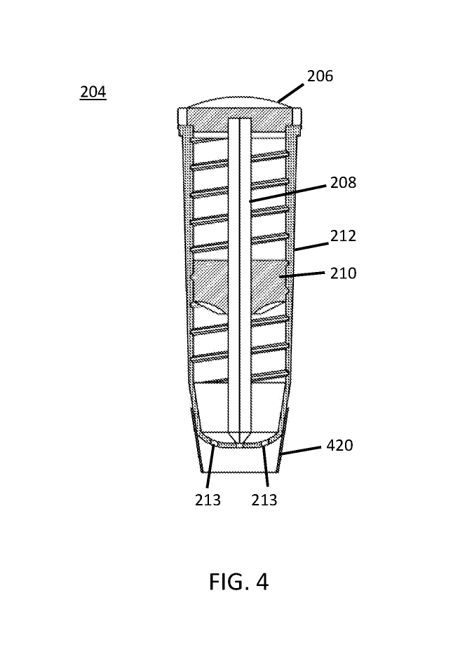

FIG. 4 shows a view of press 204 when assembled. As shown, plunger 210 is screwed into press body 212 via the mating threads on each. As a user turns handle 206, shaft 208 and plunger 210 rotate and plunger 210 moves along shaft 208 toward the top or the bottom of press body 212 based on the direction of rotation of the handle.

As also shown in FIG. 4, a screen 420 may be provided in some embodiments to capture components of food that pass through holes 213 from the inside of press body 212 but are larger than holes in the screen. Any suitable screen, with any suitably sized holes and made of any suitable material, can be used in some embodiments.

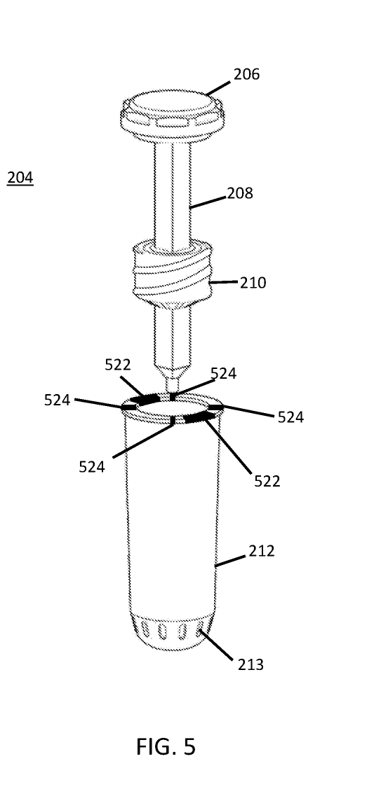

FIG. 5 shows a perspective view of food press 204. When handle 206, shaft 208, and plunger 210 are removed from press body 212 as shown, food items can be placed into, or removed from, press body 212. After food items are placed into press body 212, the plunger can be placed into the press body (e.g., using the handle and shaft) and screwed inward.

In some embodiments, plunger 210 can be removed from shaft 208 as shown in FIG. 3. In some embodiments, the plunger can be removed from the shaft by sliding the plunger off the bottom end of the shaft shown in FIG. 3. In some embodiments, the plunger can be removed from the shaft by removing handle 206 from the top end of the shaft shown in FIG. 3 and sliding the plunger off the top end of the shaft. In some embodiments, stops (not shown in the figures) near the bottom end of the shaft shown in FIG. 3 can be provided to prevent the plunger from being removed from the shaft via that end of the shaft.

Once the drinking bottle, the lid, the press body, the plunger, the shaft, and the handle are disassembled, these items can be cleaned in any suitable manner, such as by washing them by hand or by placing them in a dishwasher.

Referring back to FIG. 5, in some embodiments, openings 522 may be provided in press body 212 to allow the contents of the drinking bottle to pass by the side of the press body from the inside of the drinking bottle to the outside of the drinking bottle.

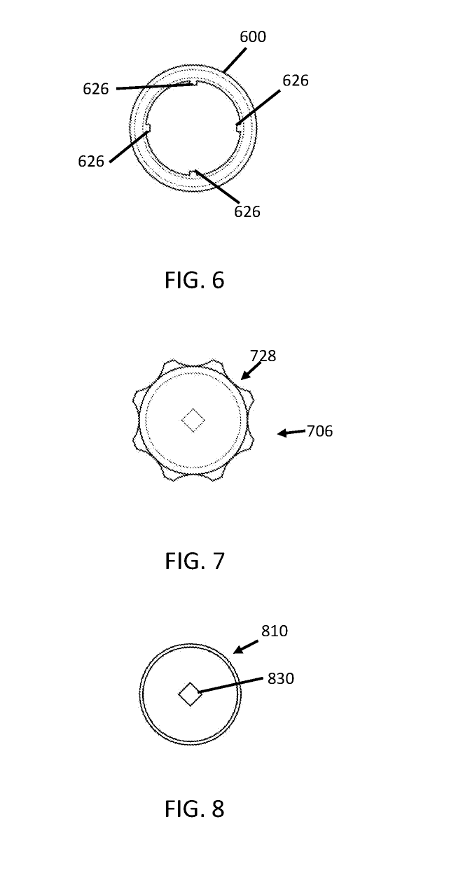

In some embodiments, notches 524 may be provided in the press body to engage mating tabs in the drinking bottle. Examples 626 of such tabs are shown in FIG. 6, which is a top down view of an example 600 of a drinking bottle (with its lid and press removed) that can be used as bottle 100 in some embodiments. When a press body having notches 524 is placed in drinking bottle 600 (e.g., as shown in FIG. 1), notches 524 and tabs 626 prevent the press body from moving with respect to the drinking bottle.

An example 706 of a handle that can be used as handle 206 in some embodiments is shown in FIG. 7. As illustrated, cut-outs 728 can be provided in handle 706 to make it easier to turn. Although handle 706 is provided herein as an example, any suitably shaped handle can be used in some embodiment.

In some embodiments, rather than plunger being manually moved by a user turning a handle, the plunger can be moved by an electric motor that is attached to the shaft or that is embedded in the plunger. Such an electric motor can be controlled by any suitable switch and powered by any suitable battery.

In some embodiments, any suitable ratcheting mechanism can be provided to controllably prevent the plunger from rotating upward in the press body due to force applied to the plunger from food items in the press body. Such a ratcheting mechanism can be provided in the plunger, the shaft, and/or the handle in some embodiments.

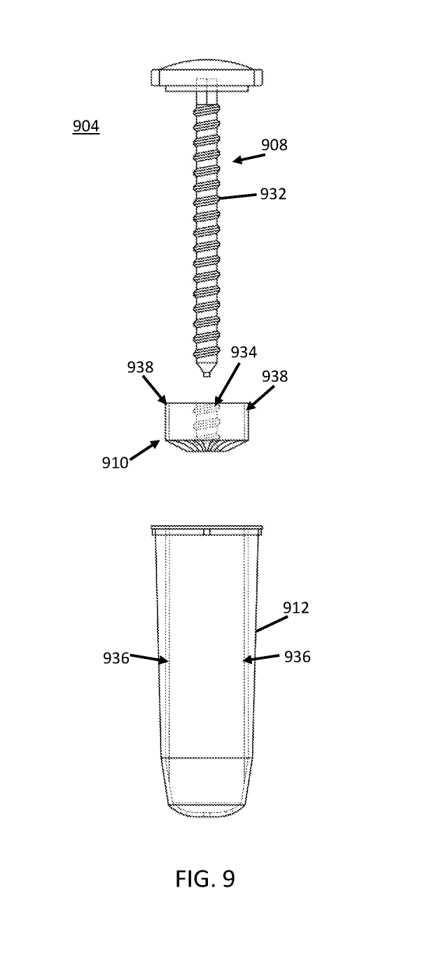

Turning to FIGS. 9, 10 and 11, another example 904 of a food press that can be used as food press 104 in accordance with some embodiments is shown. As illustrated, shaft 908 has threads 932 that mate with threads 934 of plunger 910. As shown in FIGS. 9 and 11, grooves 938 in plunger 910 can be provided. These grooves can engage rails 936 (FIG. 9) in the press body that prevent the plunger from rotating with respect to the press body. In some embodiments, rather than preventing the plunger from rotating with respect to the body, the grooves and rails can have a matched helical shape that causes the plunger to rotate at a slower rate than a rate at which the handle is rotated, thus resulting in movement along the shaft.

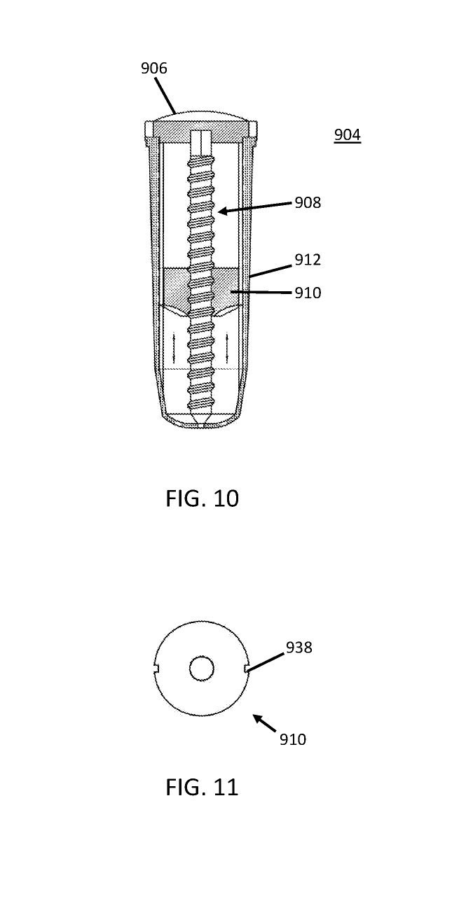

Thus, when press 904 is assembled as shown in FIG. 10, rotating handle 906 will cause shaft 908 to rotate, which will cause plunger 910 to move up or down in press body based on the direction that the handle is rotated.

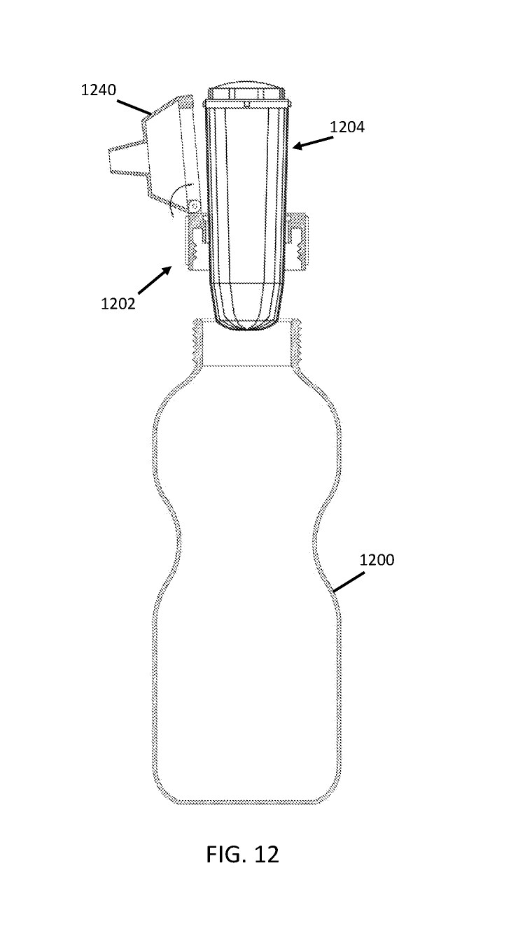

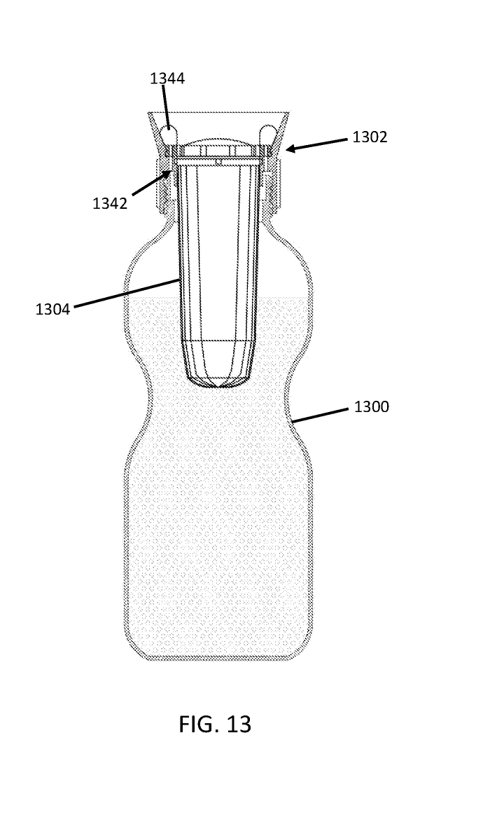

As shown in FIGS. 12 and 13, in some embodiments, rather than a food press being attached to a drinking bottle, the food press can be attached to a lid of the drinking bottle. For example, as shown in FIG. 12, a food press 1204 (which can include any of the features of any of the food presses described herein) can be attached to a lid 1202, which can then be screwed onto drinking bottle 1200. The attachment of press 1204 to lid 1202 can be performed in any suitable manner. A cap 1240 of lid 1202 can be provided to cover food press 1204 when in use and to allow a user to drink through the illustrated mouth piece.

As another example, as shown in FIG. 13, a food press 1304 (which can include any of the features of any of the food presses described herein) can be attached to lid 1302, which can then be screwed onto drinking bottle 1300. The attachment of press 1304 to lid 1302 can be performed in any suitable manner. Drinking slots 1342 can be provide in lid 1302 to allow a user to drink the contents of bottle 1300. The slots can be opened/closed by rotating tabs 1344. Alternatively, a tab 1344 may be made to open/close by lifting it up. In this instance, press handle 206 as shown in FIG. 4, may be accessible and functional externally from lid 1302. In some embodiment, the lid is made liquid tight by a rubber gasket that runs along the edges of handle 206 or along the press body opening in lid 1302.

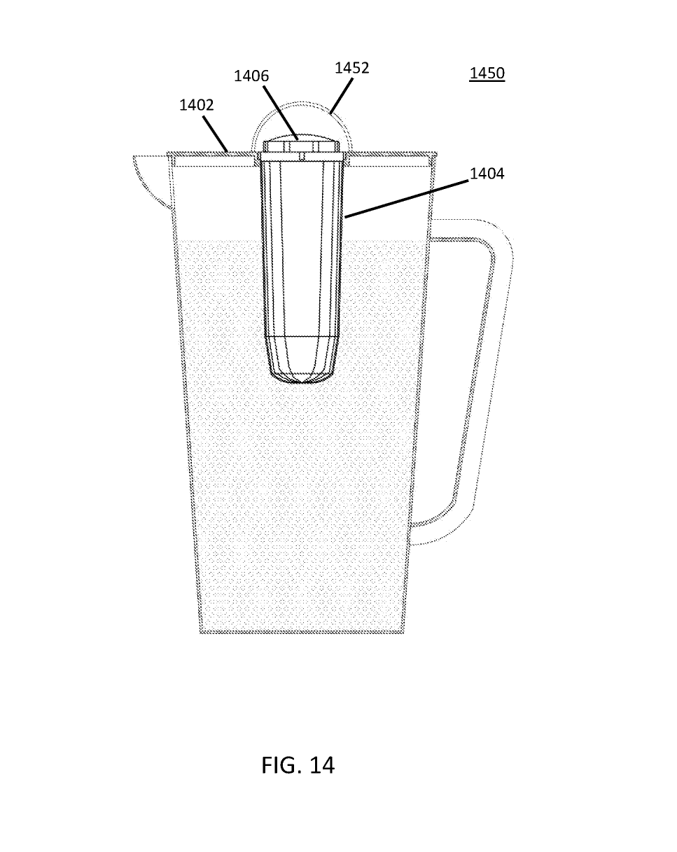

Referring to FIG. 14, additionally or alternatively a food press 1404 (which can include any of the features of any of the food presses described herein) can also be incorporated into a larger dispensing container (e.g., pitcher) 1450. Food press 1404 can be attached to a lid 1402 by notches provided in the press body engaging with mating tabs in the lid, or by any mechanism described herein. Additionally, in some embodiments, a cap 1452 may be provided to conceal and protect the food press handle 1406.

In some embodiments, a filtering plunger can be provided. In such a case, the plunger can be constructed to include any suitable filter mechanism (e.g., screen, filter paper, charcoal filter, etc.) and allow liquid to pass through the filter mechanism from one side (e.g., bottom) to the other (e.g., top). Thus, as the plunger moves with respect to the liquid, the liquid will be filtered. To facilitate this, a press body may be provided that includes one way valves on the holes near the bottom of the press body (e.g., like holes 213 (FIG. 2) that only allow liquid to enter the press body. The press body may also include holes near the top of the press body that allow liquid to be expelled from the press body into the drinking bottle. Thus, as the plunger is moved upward, liquid will be drawn into the press body through the one-way valves. As the plunger is moved downward, the liquid will not be able to pass through the one-way valves and will be forced through the plunger filter mechanism toward the top of the press body. When the plunger subsequently moves downward, liquid above the plunger will be expelled from the drinking bottle into the drinking bottle.

In some embodiments, additionally or alternatively to including a filter mechanism as described in the preceding paragraph, the plunger may include a flavor dispenser. For example, the flavor dispenser may be provided that includes a dissolvable flavor ingredient that is placed on the side of the plunger at which liquid exits the plunger when passing through it so that the liquid becomes flavored.

In some embodiments, additionally or alternatively to providing a filter in the plunger, a filter can be provided in the shaft. As shown in FIG. 3, press handle 206 may be removed from shaft 208, exposing a hollow inside of shaft. A cylindrical filter (e.g., screen, filter paper, charcoal filter, etc.) can then be inserted into shaft 208 and secured in place by replacing press handle 206. In this instance, shaft 208 comes with a porous design that allows water and particles to flow through therefore filtering the liquid.

Any of the bottles, lids, press body, handle, shaft, and plunger can be formed from any suitable material(s). For example, these components can be formed from dishwasher-safe, food-safe, non-toxic plastic(s) (e.g., bisphenol A (BPA) free plastic(s)), stainless steel, glass, etc.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A device for pressing food into liquid, comprising:
a drinking bottle having an interior portion; and
a food press mounted in the interior portion of the drinking bottle, wherein the food press comprises:
a handle;
a shaft connected to the handle so that when the handle is rotated the shaft rotates;
a plunger configured to move along the shaft in response to the shaft rotating;
a press body having an open end configured to receive the plunger, an interior portion configured to allow the plunger to move from the open end toward an opposite end of the press body; and a plurality of holes at or near the opposite end.

2. The device of claim 1, further comprising a lid to which the food press is attached.

3. The device of claim 1, wherein the drinking bottle includes at least one tab and the press body includes at least one notch, and wherein the food press is attached to the drinking bottle by the at least one tab engaging the at least one notch.

4. The device of claim 1, where in the plunger includes a grinding surface.

5. The device of claim 4, wherein the grinding surface includes a plurality of radial ridges.

6. The device of claim 1, wherein the press body includes at least one thread and the plunger includes at least one mating thread, and wherein, when the shaft rotates, the plunger moves under the interaction of the at least one thread of the press body and the at least one thread of the plunger.

7. The device of claim 6, wherein the shaft has a square cross section.

8. The device of claim 1, where the shaft has at least one thread and the plunger includes at least one thread, and wherein, when the shaft rotates, the plunger moves under the interactive of the at least one thread of the shaft and the at least one thread of the plunger.

9. The device of claim 8, wherein the plunger includes at least one groove and the press body includes one rail, wherein the plunger moves along the rail while engaged in the groove.

10. The device of claim 9, wherein each of the at least one groove and each of the at least one rail are substantially straight.

11. The device of claim 9, wherein each of the at least one groove and each of the at least one rail are helically shaped.

12. The device of claim 1, wherein the press body includes one way valves attached to the plurality of holes.

13. The device of claim 1, wherein the plunger includes a filter mechanism that filters liquid that passes through the plunger.

14. The device of claim 1, wherein the plunger includes a flavor ingredient that adds flavor to liquid passing through the plunger.
